(19) United States
(12) Patent Application Publication
(10) Pub. No.: US 2014/0247596 A1
(43) Pub. Date: Sep. 4, 2014

(54) LED PATTERN DISPLAY LAMP

(71) Applicant: POLYBRITE INTERNATIONAL, INC., Naperville, IL (US)

(72) Inventors: Carlo Scianna, Des Plaines, IL (US); Raymond G. Janik, Wheaton, IL (US)

(73) Assignee: POLYBRITE INTERNATIONAL, INC., Naperville (US)

(21) Appl. No.: 14/349,163

(22) PCT Filed: Oct. 10, 2012
(86) PCT No.: PCT/US12/59564

§ 371 Date: Apr. 2, 2014

Related U.S. Application Data
(60) Provisional application No. 61/545,358, filed on Oct. 10, 2011.

(51) Int. Cl. G09G 3/14

(52) U.S. Cl. CPC G09G 3/14
USPC 362/249.06

(57) ABSTRACT

An LED display lamp for generating an illumination of a pattern replicating a recognizable shape. The lamp has a base and an elevated light source above the base comprising a group of LEDs connected in series and mounted on one side of a generally flat substrate. A drive circuit drives the LEDs, with the drive circuit being electrically connected to the base. A plurality of the groups of LEDs is employed, depending on the recognizable shape being replicated. Multiple patterns can be separately mounted on each side of the substrate, with the patterns on each side being the same or unrelated to one another.

### BACKGROUND OF THE INVENTION

This invention is directed to LED display lamps, and in particular to an LED display lamp formed for generating an illumination of a recognizable shape.

LEDs have become a viable source of general illumination, such as explained in co-pending U.S. patent application Ser. No. 12/826,774, filed Jun. 30, 2010, entitled “LED Lamp Replacement of Low Power Incandescent Lamp”, the disclosure of which is incorporated herein by reference. This application discloses arrangement of LEDs in a series connection, producing a stand-off voltage just under the line peak voltage.

The relationship between voltage, regulation, efficiency and the input power factor of combined LEDs is explained in co-pending U.S. patent application Ser. No. 13/025,749, filed Feb. 11, 2011, entitled “Direct AC Drive for LED Lamps”, the disclosure of which is also incorporated herein by reference. That application describes the design procedure for determining the number of LEDs in series and the relationship between the power factor, efficiency and driver circuit regulation.

The applications incorporated by reference explain the utilization of low power LEDs in a layout that produces the visual effect of an incandescent lamp. LED layouts can vary from a straight line to a curved filament look, with the visual effect being that of the filament of an incandescent lamp. The visual effect is possible only with the use of sufficient LEDs that are bright enough to be used in general illumination and which are intended to replace up to 100 watt incandescent lamps.

### SUMMARY OF THE INVENTION

The invention is directed to an LED display lamp for generating an illumination of a shape, such as a symbol or logo. The lamp includes a base and an elevated light source above the base comprising a group of LEDs connected in series and mounted on one side of a generally flat substrate. A drive circuit is provided for the LEDs, the drive circuit being electrically connected to the base. The LEDs are arranged in a pattern replicating a recognizable shape.

In accordance with the preferred form of the invention, a plurality of the groups of LEDs is employed, with each group of LEDs being electrically connected in parallel with one another. In one form of the invention, the groups are arranged in sequential lines which form a recognizable shape.

In accordance with the invention, a second group of LEDs is mounted on an opposite side of the generally flat substrate in a second pattern. The pattern may be the same as the pattern of the first group of LEDs on the first side of the flat substrate, or can be different.

The drive circuit can include means for animation of the pattern, in order to give the effect of movement. Also, a plurality of patterns can be mounted on one side of the flat substrate, with each pattern of the plurality of patterns being separately activated by the drive circuit. Each pattern of the plurality of patterns can also be of a different color.

The flat substrate can be an inert material, or can comprise part of the printed circuit board for mounting of the drive circuit for the LEDs. The substrate extends generally upwardly from the base a sufficient distance so that the pattern generated by the arranged LEDs is fully visible above the base.

### BRIEF DESCRIPTION OF THE DRAWINGS

The invention is described in greater detail in the following description of examples embodying the best mode of the invention, taken in conjunction with the drawing figures, in which:

FIG. 1 illustrates one form of a circuit for driving LEDs used in the patterns according to the invention,

FIG. 2 illustrates an alternative circuit for driving the LEDs,

FIG. 3 illustrates the relationship between the power factor, efficiency and driver circuit regulation depending on the number of LEDs in series connection,

FIG. 4 illustrates one form of arrangement of the LEDs of the invention, forming a cross, and

FIGS. 5A-D illustrate examples of LED arrangements installed on the flat substrate.

### DESCRIPTION OF EXAMPLES EMBODYING THE BEST MODE OF THE INVENTION

Incorporated U.S. patent application Ser. No. 12/826,774 describes the utilization of miniature low power LEDs in a layout that replicates the visual effect of an incandescent lamp. That invention is directed to providing illumination, and replicating the illumination of the incandescent lamp that is replaced by the LED lamp of the invention.

By arranging LEDs in a pattern according to the present invention, the LEDs can replicate any symbol or logo, and can be white or any color. Just as in incorporated application Ser. No. 12/826,774, the LEDS are mounted on a generally flat substrate, typically a printed circuit board, above the base of the lamp, as shown generally in FIGS. 5A-D. Each of the lamps of FIG. 5 comprises a globe 10 extending from a screw base 12 formed for engaging a typical lamp socket. A printed circuit board 14, in the form of a flat substrate upon which the LEDs are located, extends from the base 12 into the globe 10. The LEDs are arranged in what can be an infinite number of patterns on the printed circuit board 14 replicating a recognizable shape. For example, in FIG. 5A the symbol of a ribbon is replicated, representing breast cancer awareness. Other patterns replicating recognizable shapes are shown in FIGS. 5B-D.

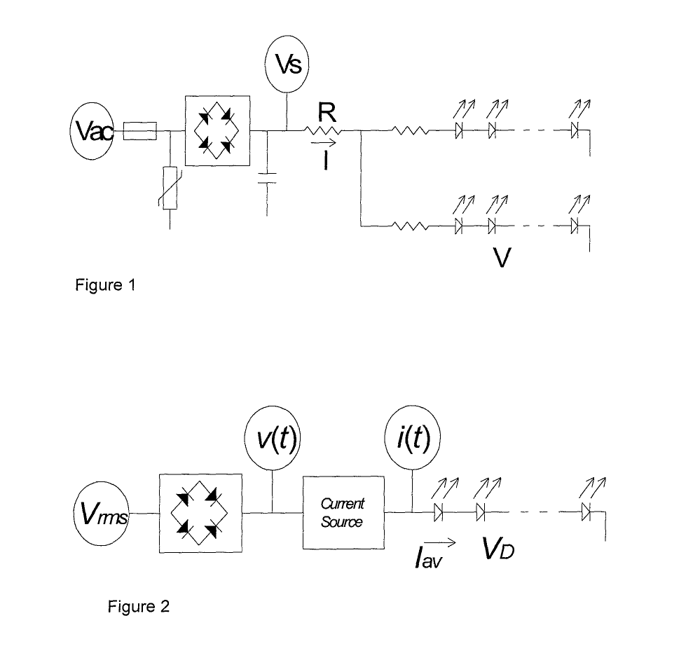

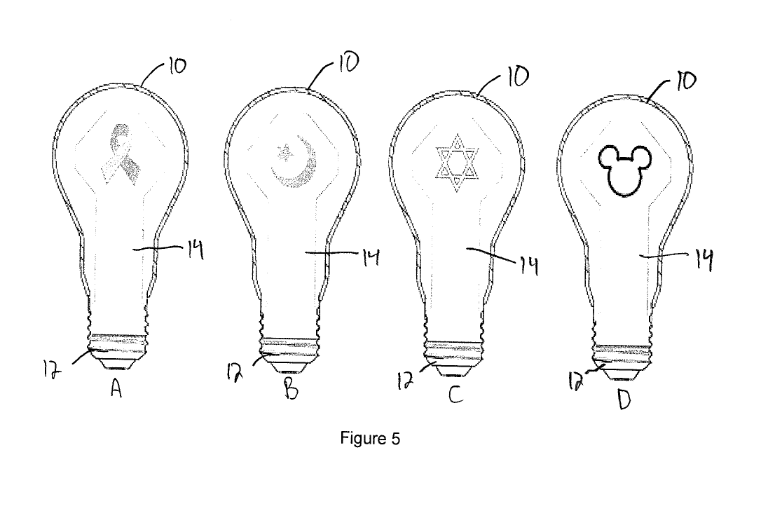

The printed circuit board 14 is shown in greater detail in FIG. 4. The printed circuit board 14 includes a base portion 16 formed to fit within the interior of the screw base 12. On the printed circuit board 14 is a drive circuit 18 which, when the printed circuit board 14 is installed in a screw base 12, is electrically connected to the base in a conventional fashion. The drive circuit 18 can be that of FIG. 1 or 2, or any circuit sufficient to drive the series-connected LEDs. The drive circuit of FIG. 1 is explained in greater detail in incorporated U.S. patent application Ser. No. 12/826,774.

The drive circuit 18 is connected to a plurality of LEDs 20 forming a desired recognizable shape. In FIG. 4, the LEDs are connected to represent a cross. In FIGS. 5A-D, other shapes and symbols are represented by the LEDs being arranged in other patterns.

FIG. 1 is a preferred circuit for driving LEDs in series to achieve a low loss current limiting arrangement. Groups of LEDs are mounted in series, and when additional groups of LEDs are needed for forming a desired recognizable shape, additional groups of LEDs are provided, with the groups being electrically connected in parallel, as shown in FIG. 1.

The screw base 12 is shaped to be installed in a typical electrical socket, such as a 110/120 volt source. Since the LEDs are driven by a high voltage, location and routing of the LED connections becomes critical, particularly when an elaborate graphic is formed. As the LED voltage of each series connection of LEDs adds up, adjacent strings of LEDs need to be maintained at a relatively low voltage to prevent arcing and failure. Typically, the voltage of each group of LEDs connected in series is maintained under 30 volts peak, and thus, as shown in FIG. 4, the routings of the LEDs are connected to be no greater than 30 volts peak. The LEDs of the base of the cross of FIG. 4 are connected in series to one another, then to the left arm of the cross where the first two LEDs of the left arm are then connected to the first LED of the top of the cross, and so on for the remainder of the connections forming the elements of the cross.

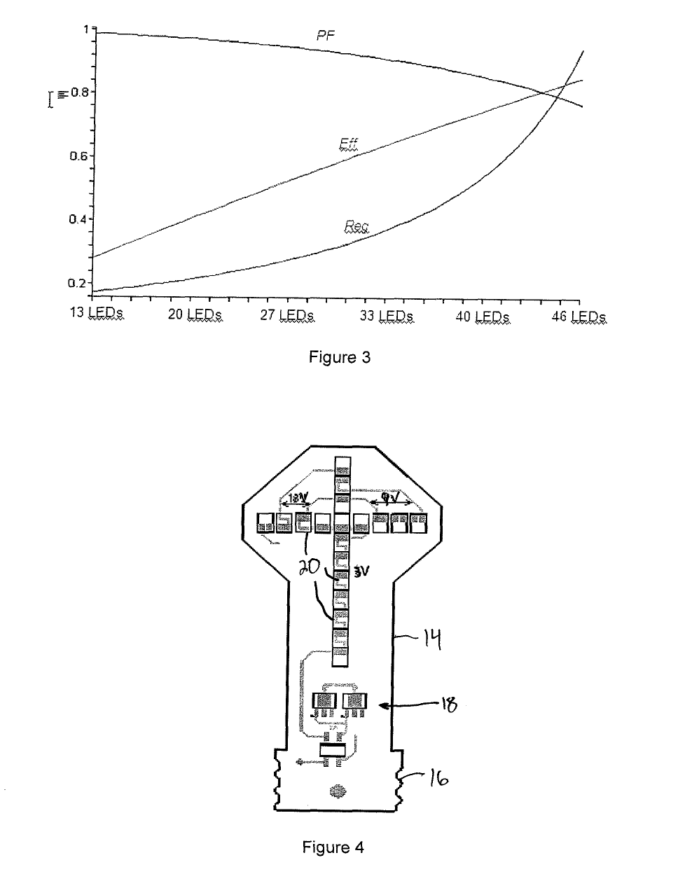

The number of LEDs in series can be determined by the design procedure outlined in incorporated U.S. patent application Ser. No. 13/025,749. As illustrated in FIG. 3, for a power factor better than 0.9, the number of LEDs must be less than 40 in series. Since it is desirable to maintain the efficiency as high as possible, it is best to maximize the number of LEDs while keeping the power factor above 0.9. A practical number of LEDs is between 32 and 42 in series, with the optimal number of LEDs being 38. The corresponding driver efficiency is thus approximately 0.7 (70%).

If the particular recognizable shape being replicated requires more than the optimal number of LEDs, a plurality of groups of LEDs can be employed. For example, if the optimal number of LEDs is 38, and more LEDs are required to produce a desired effect, the next number of LEDs would be two parallel groups of LEDs, each of 38, or therefore 76, each arranged in two parallel circuits of 38 LEDs each. The next number would be three groups, or 114 LEDs, and so on. Furthermore, while the desired number of LEDs of each group is, as noted above, between 32 to 42, if efficiency is not of concern, then the number of LEDs can be reduced, with a corresponding reduction of efficiency as shown in FIG. 3.

Each LED is preferably small so as to increase the resolution of the image being produced by the groups of LEDs. Pinpoint LEDs are particularly effective in producing lines.

The invention can also be used to produce animation and special effects. The drive circuit 18 can comprise selectively powered LED circuits for individually driving a group or groups of LEDs. To provide an animation effect, energy storage devices, such as capacitors, can be used for each circuit, since such devices take time to charge and discharge, and therefore circuits can be energized in various patterns, producing animation.

A number of LED circuit arrangements can be mounted on one side of the printed circuit board, and separately energized. For example, all of the circuit arrangements shown in FIGS. 5A-D can be mounted on the same printed circuit board, each being energized by a separate circuit in the drive circuit 18, which can be manually selected to produce the illumination of one or more of the patterns shown in FIG. 5.

Other effects can be produced by utilizing multi-color LED chip-on-board that change color depending on an embedded code that can be changed as desired. Thus, the same pattern can be energized in varying colors.

The LEDs of the invention can be arranged in exactly the same relative location on either side of the printed circuit board 14, therefore replicating a common shape in a display lamp. However, the LEDs can also be arranged in two entirely different graphic patterns, one on each side of the printed circuit board, with the patterns having no relationship to one another.

The preferred method of driving the LEDs, in accordance with the incorporated applications, is a direct AC drive with linear constant current or a passive limiting resistor. The number of LEDs in each group of LEDs is derived from FIG. 3. The LEDs can also be driven by a switch mode power supply. The power supply can have an isolated or non-isolated fly-back converter, or a non-isolated buck converter. If so, any number of LEDs can be used in series.

Various changes can be made to the invention without departing from the spirit thereof or scope of the following claims.

What is claimed is:

1. An LED display lamp for generating an illumination of a shape, comprising
a. a base,
b. an elevated light source above said base comprising a group of LEDs connected in series and mounted on one side of a generally flat substrate,
c. a drive circuit for said LEDs, said drive circuit being electrically connected to said base, and
d. said LEDs being arranged in a pattern replicating a recognizable shape.

2. The LED display lamp according to claim 1, including a plurality of said groups of LEDs, said groups of LEDs being electrically connected in parallel with one another.

3. The LED display lamp according to claim 2, in which said groups are arranged in sequential lines forming said recognizable shape.

4. The LED display lamp according to claim 1, in which a second group of LEDs is mounted on an opposite side of said generally flat substrate in a second pattern.

5. The LED display lamp according to claim 4, in which said second pattern is different from said pattern of the first group of LEDs.

6. The LED display lamp according to claim 1, in which said drive circuit includes means for animation of said pattern.

7. The LED display lamp according to claim 1, including a plurality of said patterns mounted in said one side.

8. The LED display lamp according to claim 7, in which each pattern of said plurality of patterns is separately activated by said drive circuit.

9. The LED display lamp according to claim 7, in which each pattern of said plurality of patterns is a different color.

10. The LED display lamp according to claim 1, in which said substrate comprises a printed circuit board.
